(19) United States
(12) Patent Application Publication
(10) Pub. No.: US 2025/0048025 A1
(43) Pub. Date: Feb. 6, 2025

(54) Loudspeaker Placement Identification Based on Directivity Index

(71) Applicant: Samsung Electronics Co., Ltd., Suwon-si (KR)

(72) Inventors: Adrian Celestinos Arroyo, Valencia, CA (US); Zhongran Wang, Valencia, CA (US); Victor Manuel Chin Lopez, Tijuana (MX)

(21) Appl. No.: 18/782,260

(22) Filed: Jul. 24, 2024

Related U.S. Application Data
(60) Provisional application No. 63/530,118, filed on Aug. 1, 2023.

(51) Int. Cl. H04R 1/40; H04R 3/14

(52) U.S. Cl. CPC H04R 1/403; H04R 3/14; H04R 2201/401; H04R 2430/01

(57) ABSTRACT

In one embodiment, a method includes determining human directivity index (DI) pattern data corresponding to a location of a listener, based on vocalization recorded by a microphone at each of a plurality of loudspeakers. The method further includes extracting a set of DI features from the DI pattern data; providing the set of DI features to a trained machine-learning model; and determining, by the trained machine-learning model and based on the set of DI features, a placement of each of the plurality of loudspeakers relative to the listener.

### PRIORITY CLAIM

This application claims the benefit under 35 U.S.C. § 119 of U.S. Provisional Patent Application No. 63/530,118 filed Aug. 1, 2023, which is incorporated by reference herein.

### TECHNICAL FIELD

This application generally relates to loudspeaker placement identification based on human directivity index.

### BACKGROUND

A loudspeaker converts an electrical audio signal into a corresponding sound. Loudspeakers can be used for playing music, listening to audio content corresponding to video content (e.g., audio of a TV show or a movie), etc. An entertainment system often involves multiple loudspeakers that play audio. For example, an entertainment system may include a pair of left-right stereo loudspeakers, a subwoofer, a center loudspeaker, a pair of left-right surround loudspeakers, and/or a pair of left-right rear surround loudspeakers. The number of loudspeakers in a system are often referred to by an x.y convention, where x is the number of loudspeakers used in the system and y refers to the number of subwoofers used in the system.

In order to optimize sound quality, loudspeakers in an entertainment system are designed to have a specific placement relative to a listener. For instance, an ideal angle and distance from each loudspeaker to a listener may be specified, for example by the recommendations set forth in the ITU-R BS.2159-4 standard.

### BRIEF DESCRIPTION OF THE DRAWINGS

FIG. 1 illustrates an example method for determining the placement of loudspeakers in an entertainment system relative to a listener's location.

FIG. 2 illustrates an example of certain steps of the method of FIG. 1.

FIG. 3 illustrates an example training method that involves simulated data.

FIG. 4 illustrates an example randomized placement of a 4-loudspeaker system relative to a listener.

FIG. 5 illustrates an example of simulated DI data from a simulated 4-loudspeaker system.

FIG. 6 illustrates an example computing system.

### DESCRIPTION OF EXAMPLE EMBODIMENTS

In order to optimize sound quality, loudspeakers in an entertainment system are designed to have a specific placement relative to a listener. For instance, an ideal angle and distance from each loudspeaker to a listener may be specified, for example by the recommendations set forth in the ITU-R BS.2159-4 standard. However, in actual use, loudspeakers' positions and orientations often vary from recommended values. For instance, room design and dimensions may limit the placement of loudspeakers to specific positions that differ from those suggested by recommended values. In addition, loudspeaker setup is often imperfect, for example because a user may not orient a loudspeaker exactly as specified by a recommendation. In addition, recommended loudspeaker positions and orientations are relative to a specific listener location, and therefore a listener who is in a different location relative to the entertainment system experiences relative loudspeaker locations and orientations that differ from the recommended values.

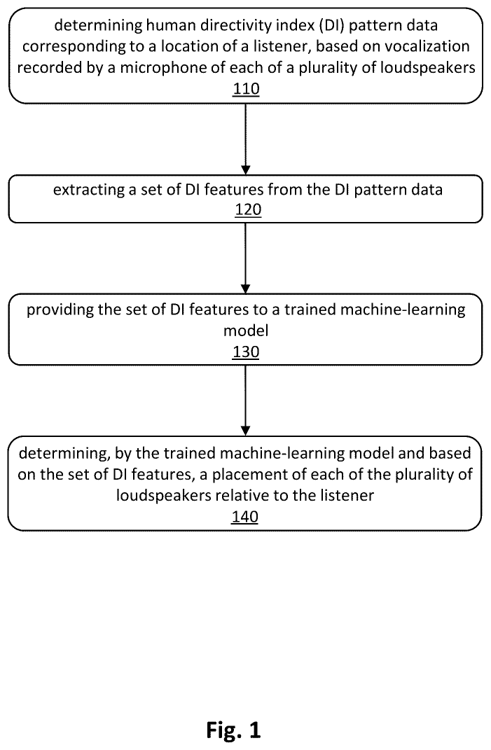

FIG. 1 illustrates an example method for determining the placement of loudspeakers in an entertainment system relative to a listener's location. As explained below, the placement of a loudspeaker can include the loudspeaker's position relative to the listener, the loudspeaker's orientation relative to the listener, or both the loudspeaker's position and orientation relative to the listener. As explained below, once the placement of each loudspeaker is determined, then particular embodiments can use the collective placement information to adjust the system's sound field (e.g. volume level of one or more loudspeakers) and/or apply a spatial correction, for instance so that the listening experience is closer to that provided by recommend loudspeaker placement criteria or closer to the listening experience intended by a composer of the audio. For example, if a loudspeaker system is not correctly placed with respect to a listener, then delays can be introduced corresponding with the propagation distance from the closest loudspeaker to the further loudspeaker, so that sound from each loudspeaker reaches the listener as if the listener were positioned in the recommended location relative to the collective loudspeaker system. In particular embodiments, a notification may be provided to a listener to adjust their listening position or to adjust the placement of one or more loudspeakers to improve their listening experience, based on the determined loudspeaker placement relative to a listener.

Step 110 of the example method of FIG. 1 includes determining human directivity index pattern data corresponding to a location of a listener, based on vocalization recorded by a microphone at each of multiple loudspeakers (each microphone may be part of, mounted on, or otherwise co-located with one of the loudspeakers). The human voice does not radiate sound uniformly around the head; instead, more energy is radiated forward than backwards due to the mouth location in the head, and therefore the human voice presents a specific directivity pattern that depends on acoustic frequency, the angle/direction of the speaking person, and the distance to the speaking person. The directivity index (DI) is a measure that represents this directivity pattern.

A vocalization may be a particular predetermined word or phrase. In particular embodiments, the method of FIG. 1 may begin with a vocalization command, which when detected by a microphone, activates the microphones at each loudspeaker or otherwise initiates the method of FIG. 1. The command may also be the vocalization referred to in step 110, upon which the DI measurement is based, or the command may precede this vocalization. A user may initiate the loudspeaker-placement method of FIG. 1 upon command (whether verbal or non-verbal, e.g., via a UI on a wirelessly connected or wired device, such as a TV, a smartphone, etc.). In particular embodiments, the method of FIG. 1 may be used during an initialization phase when setting up an entertainment system. In particular embodiments, the method of FIG. 1 may be repeated periodically to determine whether listeners are frequently outside of the recommended listening position relative to the loudspeakers. In particular embodiments, previously or frequently used listener locations determined by implementing the method of FIG. 1 may be stored so that a user or the system can subsequently select a particular previously determined listener location without repeating the method of FIG. 1.

A vocalization may be recorded by a microphone at each loudspeaker. Each loudspeaker is co-located with at least one microphone. The microphone may be a near-field microphone, and the microphone may be located near the main loudspeaker driver.

DI values represent the ratio of acoustical energy measured in one specific direction to the acoustic energy output by a source in all directions. For example, DI may be a calculated as:

$$DI ( w ) = 10 {log}_{10} \frac{{\vert {H}_{0} ( w ) \vert}^{2}}{\frac{1}{N} {\sum }_{n = 0}^{N - 1} {\vert {H}_{0} ( w ) \vert}^{2}} \qquad ( 1 )$$

where H is the sound pressure (H₀ refers to the sound pressure at 0 degree in this example); w is the angular frequency ω=2πf, where f refers to discrete frequency bands; and N is the total number of directions being measured.

In particular embodiments, signal processing may be performed on recorded vocalization data before determining DI data from the vocalization. For instance, the recorded audio may be passed through a high-pass filter (e.g., at 100 Hz) to remove unwanted low frequency noise. As another example, the vocalization data captured by each microphone may be segmented into a number of frequency-range bands across the typical frequencies used by human speech. For example, vocalization data may be segmented into frequency bands centered on 250 Hz, 500 Hz, 1 kHz, 2 kHz, 4 kHz and 8 kHz, although this disclosure contemplates that more or fewer frequency bands may be used, and bands may be centered on different frequencies than those described in the preceding example.

In particular embodiments, a filter may be applied to recorded data on each microphone/loudspeaker. For example, ⅓^{rd} octave-band filters with center frequencies may be applied to the recorded audio, and this disclosure contemplates that other filters may be used. In particular embodiments, the average energy in each filtered frequency band may then be determined for each recording. In particular embodiments, if a loudspeaker has more than one microphone, then the coincident recordings by the microphones of that loudspeaker may be combined, e.g., the average energy in a particular filtered band may be averaged among the microphones in the loudspeaker.

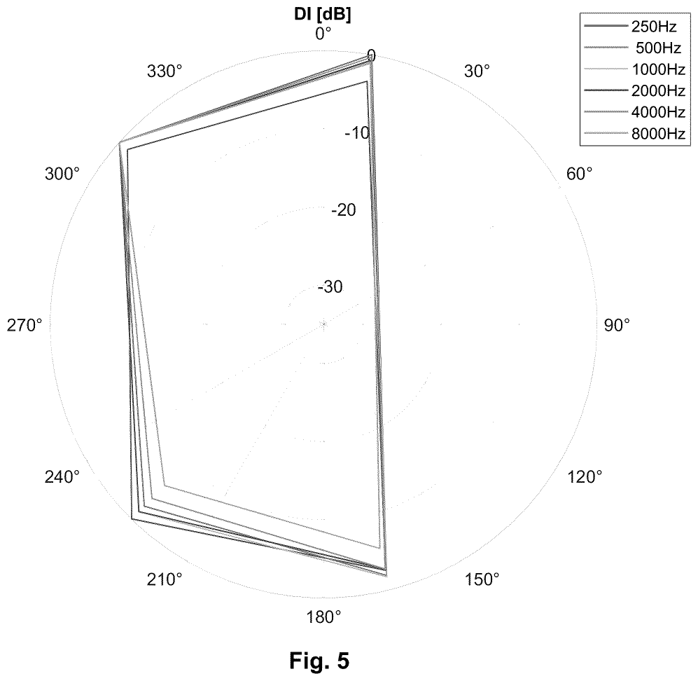

In particular embodiments, DI data may be obtained for each frequency band and for each microphone at each loudspeaker. For instance, if the system includes 4 loudspeakers and 6 frequency bands, the 24 DI values are obtained, one for each loudspeaker for each channel. In particular embodiments, the DI data may be normalized per band, for instance by normalizing the highest DI value for a particular band to 0 decibels (dB), and then adjusting each other DI value in that band accordingly relative to the 0 dB band. An example table of DI values (in dB) for a system that includes 4 loudspeakers and 6 example bands is as follows:

| | 250 | 500 | 1000 | 2000 | 4000 | 8000 |
|---|---|---|---|---|---|---|
| L | −1.38 | −0.02 | 0.00 | 0.00 | 0.00 | 0.00 |
| R | −3.46 | 0.00 | −0.96 | −0.76 | −0.36 | −1.12 |
| RB | −2.55 | −1.88 | −1.70 | −2.73 | −2.72 | −5.44 |
| LB | 0.00 | −2.28 | −1.27 | −1.30 | −3.68 | −5.99 |

Where the top row identifies each band in Hz and leftmost column identifies each loudspeaker, where L is the left loudspeaker, R is the right loudspeaker, RB is the right-back loudspeaker, and LB is the left-back loudspeaker in this example. As explained above, each column (band) contains a normalized 0 dB DI value, and the remaining values for that band are normalized accordingly. DI data may be represented graphically, for example as illustrated in FIG. 5, which illustrates an example of simulated DI data collected from a simulated 4-louspeaker system. The example DI data illustrated in FIG. 5 corresponds to the DI data presented in the table above.

Step 120 of the example method of FIG. 1 includes extracting a set of DI features from the DI pattern data, and step 130 of the example method of FIG. 1 includes providing the set of DI features to a trained machine-learning model. Step 140 of the example method of FIG. 1 includes determining, by the trained machine-learning model and based on the set of DI features, a placement of each of the plurality of loudspeakers relative to the listener. This disclosure contemplates that steps 120-140, as well as step 110, may be performed by any suitable computing device or combination of computing devices. For example, steps 110-140 may be performed by one of the loudspeakers in the entertainment system, by a connected local or server device, or by a combination of devices (e.g., one device may perform one or more steps, while another device performs other steps, etc.).

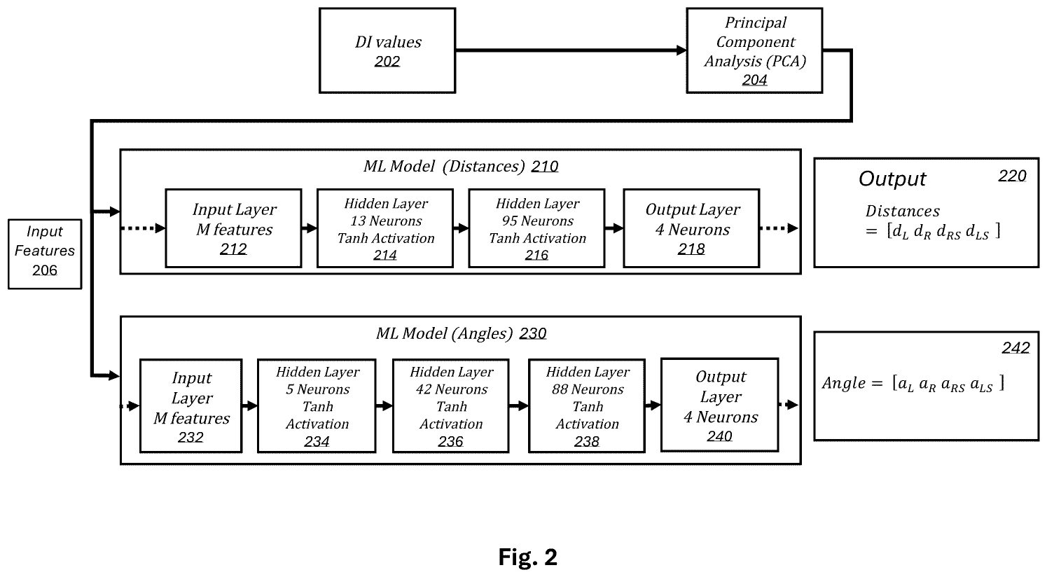

FIG. 2 illustrates an example of steps 120-140 of the method of FIG. 1. In FIG. 2, DI values 202 undergo principal component analysis 204, which essentially removes redundant information and thereby identifies a subset of the most meaningful loudspeaker-placement features. For instance, as explained more fully below, a 40-dimensional input vector may be reduced to 36 features. In steps 120-140 at least the DI features are used; in particular embodiments, additional data and corresponding features may also be used as input to the machine-learning model. For example, and as explained below, particular embodiments may train a machine-learning model based both on DI values and on inter-loudspeaker distances, and for such models step 130 includes extracting features from the DI pattern data and from the inter-loudspeaker distances, and step 140 includes determining the placement of each of the plurality of loudspeakers based on the extracted DI/inter-loudspeaker distance features. While the example of FIG. 2 uses principal component analysis to extract features from the DI values, other feature-extraction techniques may be used. In particular embodiments, the DI values themselves (e.g., channelized DI values) may be the features extracted in step 120, e.g., the DI values may be placed directly into a M dimensional vector, where M is the number of features subsequently input to the machine-learning model. In FIG. 2, applying principal component analysis 204 to DI values 202 results in the set of extracted input features 206.

Features 206 are input to machine-learning model 210, which in the example of FIG. 2 is a neural network. The neural network includes an M-dimensional input layer (where M is typically the number of features, which are extracted from the DI pattern data or from the DI pattern data and additional data, such as inter-loudspeaker distances), two hidden layers 214 and 216, and an output layer 218. The result of output layer 218 of machine-learning model 210 is a set of distance values 220, where each distance value specifies an estimated distance between the listener and a corresponding respective loudspeaker.

The example of FIG. 2 includes two distinct machine-learning models: model 210, which outputs estimated distances between a listener and each loudspeaker, and model 230, which outputs estimated angles of each loudspeaker relative to the listener. Therefore, FIG. 2 illustrates an embodiment in which two separate machine-learning models are trained and subsequently used to identify particular placement attributes of each loudspeaker. However, particular embodiments may train and use a single machine-learning model to determine both loudspeaker distances and loudspeaker angles, although this approach may have reduced accuracy relative to an approach that uses separate models.

In particular embodiments, a separate model may be trained and subsequently used for different numbers of loudspeakers in an entertainment system. For instance, a 4-loudspeaker system may have a dedicated pair of models to predict placement of those four loudspeakers, while a 5-loudspeaker system has a separate dedicated pair of models, and so on. An example of this embodiment is illustrated in FIG. 2, in which models 210 and 230 have four neurons in the output layer, and therefore correspond specifically to a 4-loudspeaker system. In particular embodiments, one or more models may be more generally trained to predict placement for a range of loudspeakers (e.g., for 4-7 loudspeakers) or for any number of loudspeakers, but this approach may have reduced performance relative to embodiment that use dedicated models for each particular number of loudspeakers.

As discussed above, FIG. 2 illustrates an example of step 140 in which the placement data includes distance estimates 220 from model 210 and also orientation (angle) estimates from model 230. To obtain the angle estimates, the M features 206 are input to the (typically M-dimensional) input layer 232. Model 230 includes 3 hidden layers 234, 236, and 238, and a four-dimensional output layer 240, which outputs angles 242: one angle, relative to the listener, for each loudspeaker in the 4-loudspeaker system that is the focus of the example of FIG. 2.

The example of FIG. 2 illustrates that machine-learning model 210 for estimating distances includes two hidden layers, where the first hidden layer 214 contains 13 neurons and a second hidden layer 216 contains 95 neurons. This particular architecture-two hidden layers, each having the number of neurons specified—may be particularly well suited to estimating the distance values of a 4-loudspeaker system when using a neural network as the machine-learning model. Likewise, FIG. 2 illustrates an example in which model 230 for estimating angles includes three hidden layers, where a first hidden layer 234 includes 5 neurons, a second hidden layer 236 includes 42 neurons, and third hidden layer 238 includes 88 neurons. This particular architecture—three hidden layers, each having the number of neurons specified—may be particularly well suited to estimating the angles of a 4-loudspeaker system when using a neural network as the machine-learning model. However, this disclosure contemplates that other numbers of hidden layers and neurons may be used, both by a 4-loudspeaker neural-network model and by neural-network models used for other numbers of loudspeakers. For example, an n-loudspeaker system may have dedicated distance and angle neural network models, and those models may have a number of hidden layers and/or number of constituent neurons that are particularized to the n-loudspeaker system. For instance, the number of layers and neurons to use for a particular n-loudspeaker placement neural-network model may be determined using Bayesian optimization on a model-by-model basis. Finally, while neural networks are used in the example of FIG. 2, this disclosure contemplates that other machine-learning models may be trained and used to determine placement values from DI data determined by a listener's vocalization.

As discussed above with respect to the example method of FIG. 1 and the example architecture of FIG. 2, the machine-learning model(s) used to determine placement values are trained prior to being deployed for run-time inferencing. Training may be based on simulated training data, real training data, or a combination therefore. For instance, the following discussion provides a detailed example of training using simulated data.

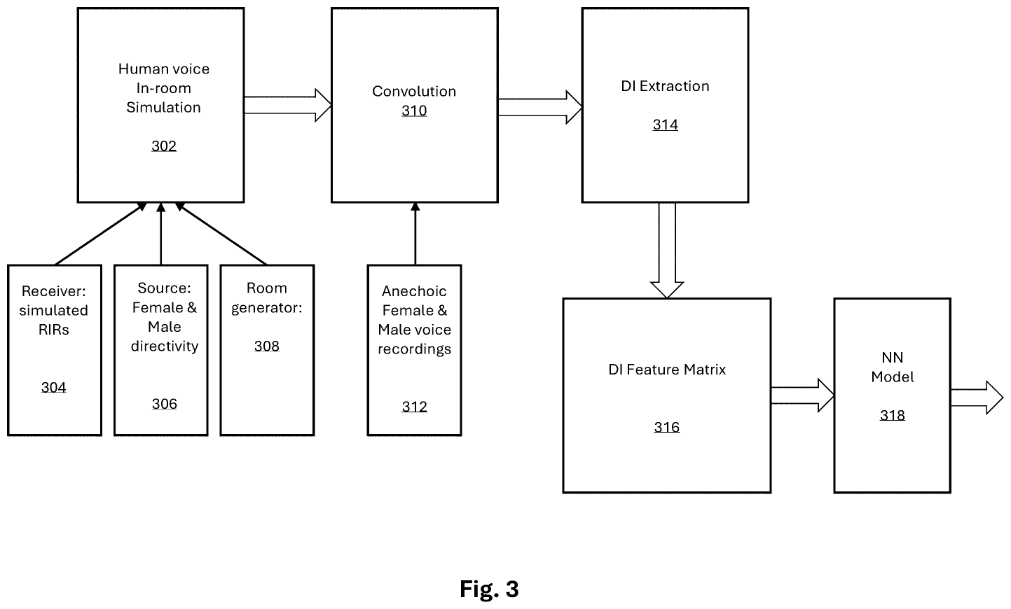

FIG. 3 illustrates an example training method that involves simulated data. Step 302 includes defining room and voice characteristics for a simulated in-room vocalization. Step 302 includes simulating receivers (microphones) 304, which includes specifying a directional room impulse response (RIR) and a location for each microphone. The simulated microphone(s) may match the characteristics of real microphones used in a particular loudspeaker or entertainment system, so that the simulated data is particularized to that system or loudspeaker. As a result, in particular embodiments, a model can be trained on data specific to the microphone(s) in a particular real system, and this model can be deployed for that particular system or for similar systems containing similar microphones. In other embodiments, a model may be trained with data from a range of microphone types and may be deployed for systems more generally; loudspeaker or microphone make/models may then be specified prior to inference by a user, in particular embodiments.

In the acoustic room simulation example of FIG. 3, step 302 includes specifying a simulated source 306, which includes specifying female or male human directivity impulse responses. Step 302 also includes a room generator 308 for specifying relevant room parameters for a set of simulated rooms. Rooms may be various sizes, dimensions, and shapes in order to simulate a broad range of room dynamics. For instance, a room size may be randomly selected from among the following parameters: (1) height=2.7-3.0 meters; (2) width=4.0-8.0 meters; and (3) length=6.0-12.0 meters. In particular embodiments, room dimensions may be simulated so that there are roughly an equal number of simulated rooms in particular room-size categories, e.g., small size (80-150 cubic meters), medium size (150-220 cubic meters), and large size (220-300 cubic meters). Room parameters may include specifying building materials for the room, such as plasterboard on frame 100 mm cavity; mineral wool in cavity, surface painted; double glazing, 2-3 mm glass, 10 mm air gap; plywood, hardwood panels over 25 mm airspace; wooden floor on joists; rubber floor tiles; carpet, thin, over thin felt on wood floor; plasterboard on frame 100 mm cavity. The preceding details regarding particular room dimensions, size categories, and characteristics provide examples of parameters that may be simulated, and other parameters or different values for these parameters may be used for room simulation. In addition, simulated (or real) data may be focused on particular sizes or parameters in order to train a loudspeaker-placement model specific to those sizes and/or parameters. For instance, real or simulated data may focus on small rooms with carpet, in order to train and deploy a model specific to those characteristics.

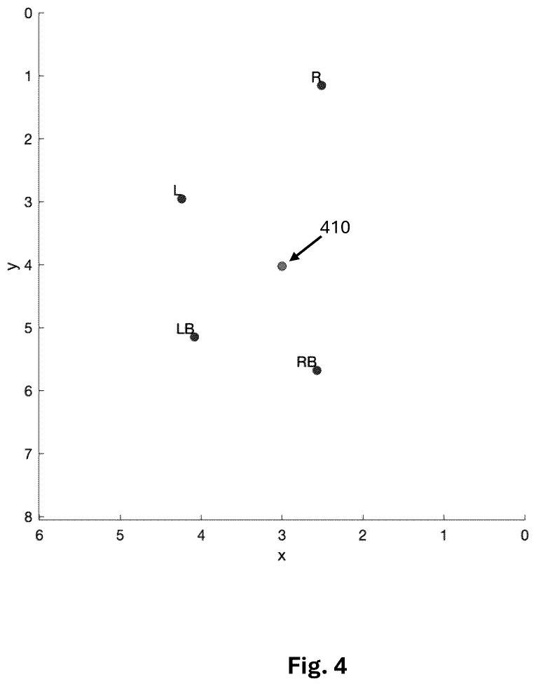

Step 302 includes specifying the placement of each loudspeaker and the source listener in each simulated room configuration. FIG. 4 illustrates an example randomized placement of a 4-loudspeaker (a left loudspeaker L, a right loudspeaker R, a left-back loudspeaker LB, and a right-back loudspeaker RB) setup relative to a listener/source 410. In particular embodiments, the placement of each loudspeaker may be constrained to particular ranges, e.g., each loudspeaker may be placed in its recommended position relative to the user and then adjusted by a particular, randomized offset between a maximum/minimum offset. As another example, each loudspeaker may be rotated from the recommended position by a randomized offset within a predetermined clockwise/counterclockwise angle range.

Step 310 of the example of FIG. 3 includes convolving each microphone's RIR with the audio of female and male audio recordings 312 of a voice command (word, phrase, etc.) previously recorded in anechoic conditions. In the example of simulated training data, the result of convolution step 310 is the simulated recorded audio at each microphone. Step 314 then includes extracting the DI values from this simulated recorded audio, as described above. While the example of FIG. 3 relates to simulating room conditions, loudspeaker placement, and microphone attributes to simulate audio received at each simulated microphone, training data may also include real training data obtained by setting up real rooms with real loudspeakers and real microphones and recording a vocalization of real male and female voices in that room. However, generating real data may be much more labor intensive, particularly when generating a large number of training samples across a wide range of room conditions. For example, training data may comprise 1000 or more training samples (e.g., 500 simulated rooms, each having a male vocalization and a female vocalization), and generating this many real-world training samples may be more labor intensive than generating simulated training samples.

Whether using real or simulated training data, DI values are extracted from (real or simulated) recorded audio for a particular room/loudspeaker setup. The DI values can be processed, for example as described above with respect to table 1. The resulting DI values can be represented as a S×C matrix, where S is the number of loudspeakers and C is the number of frequency bands, for example as illustrated in step 316 of FIG. 3. In addition, particular embodiments may use inter-loudspeaker distances during both the training phase and the subsequent inference phase. For example, inter-loudspeaker distances may be represented as an S×S matrix, with each element representing the distance between the ith and jth loudspeakers, where both i and j run over all loudspeaker indices. The distance values may refer to the distance between the ith loudspeaker's driver coordinates and the jth loudspeaker's microphone coordinates, for example in order to account for the offset between the microphone positions (which record the training audio) and the loudspeaker driver positions.

The training data may be combined into a single vector of N dimensions, where, for example, N equals SxC plus SxS for embodiments in which the model is trained both on DI data and on inter-loudspeaker distances. For instance, in a 4-loudspeaker setup using 6 bands, N equals 40. As described above, feature selection may be performed on this vector to extract features, and the resulting features are input to a machine-learning model, such as neural network model 318 of FIG. 3. The real or synthetic training data is divided into training, testing, and validation segments, and training of the machine-learning model proceeds accordingly.

In the example of FIG. 2, training neural-network model 210 can proceed by using the following parameters: max epochs: 20,000; max fail: 5,000; optimizer: scaled conjugated gradient (SCG); goal: 0; min gradient: 10⁻⁶; mu: 0.005; sigma: 5×10⁻⁵; lambda: 5×10⁻⁷; and performance function: sum square error. Training neural-network model 230 can proceed by using the following parameters: max epochs: 20,000; max fail: 5,000; optimizer: scaled conjugated gradient (SCG); goal: 0; min gradient: 10⁻⁶; mu: 0.005; sigma: 5×10⁻⁵; lambda: 5×10⁻⁷; and performance function: sum square error. However, these specific training parameters are merely one example approach for training these machine-learning models to infer loudspeaker placement, and any suitable training parameters may be used depending on the desired resolution, compute resources, and properties of the trained model(s).

In particular embodiments, the relative propagation delays between loudspeakers can be estimated by recording a vocalization from the user to each loudspeaker's microphone(s), and then using a cross-correlation algorithm to obtain the delay differences between the loudspeakers. A geometric model and least squares approach to obtain the absolute distance between the user and the loudspeaker can be employed, then the incidence angle from loudspeaker to the user can be obtained analytically. These distance/angle determinations can be made in addition to (e.g., as a check on), or in the alternative to, the ML-based approach described above. Moreover, in particular embodiments the distance from each loudspeaker to a listener can be obtained by other approaches such as direct measurement by the user, or by using a mobile phone with a gyroscope incorporated, or by measurement of impulse response with an external microphone (such as the microphone included in the mobile phone). In such instances, these measurements may be used instead of, or in addition to, recordings made by in-speaker microphones.

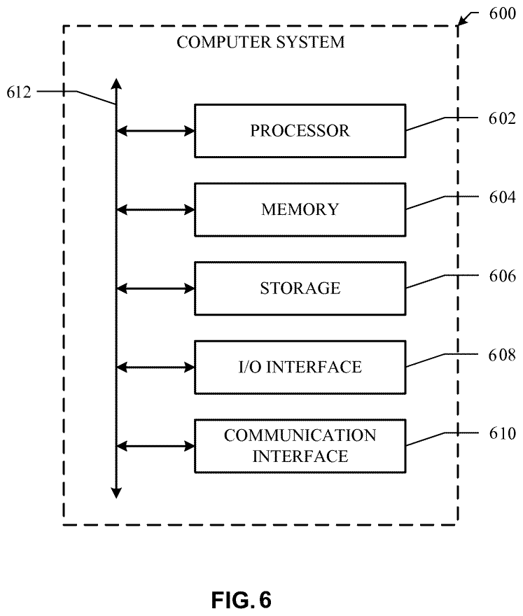

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
determining human directivity index (DI) pattern data corresponding to a location of a listener, based on vocalization recorded by a microphone at each of a plurality of loudspeakers;
extracting a set of DI features from the DI pattern data;
providing the set of DI features to a trained machine-learning model; and
determining, by the trained machine-learning model and based on the set of DI features, a placement of each of the plurality of loudspeakers relative to the listener.

2. The method of claim 1, further comprising adjusting, based on the determined placement of each of the plurality of loudspeakers relative to the listener, an audio playback setting of one or more of the plurality of loudspeakers.

3. The method of claim 2, wherein the audio playback setting comprises a spatial perception correction.

4. The method of claim 1, wherein the placement comprises a distance of each of the plurality of loudspeakers relative to the listener.

5. The method of claim 1, wherein the placement comprises an angle of each of the plurality of loudspeakers relative to the listener.

6. The method of claim 1, wherein the trained machine-learning model comprises a trained neural network.

7. The method of claim 6, wherein the trained neural network is specific to a number of loudspeakers of the plurality of loudspeakers.

8. The method of claim 1, wherein the DI pattern data comprises a DI value in each of a plurality of frequency bands for each of the plurality of loudspeakers.

9. The method of claim 1, further comprising:
detecting a predetermined command vocalization by the listener; and
determining the human DI pattern data in response to detecting the predetermined command vocalization.

10. The method of claim 1, wherein:
the trained machine-learning model comprises a first neural network trained to determine a relative distance between each of the plurality of loudspeakers and the listener; and
the method further comprises:
providing the set of DI features to a trained second neural network trained to determine a relative angle between each of the plurality of loudspeakers and the listener;
determining, by the trained second neural-network and based on the set of DI features, the angle of each of the plurality of loudspeakers relative to the listener.

11. The method of claim 1, wherein:
the trained machine-learning model is trained on training data comprising (1) a set of training DI pattern data and (2) a corresponding set of inter-loudspeaker distances; and
the method further comprises:
determining a set of inter-loudspeaker distances between the plurality of loudspeakers;
extracting a set of loudspeaker-distance features from the set of inter-loudspeaker distances; and
determining, by the trained machine-learning model, the placement of each of the plurality of loudspeakers relative to the listener based on the set of DI features and the set of loudspeaker-distance features.

12. One or more non-transitory computer readable storage media storing instructions that are operable when executed to:
determine human directivity index (DI) pattern data corresponding to a location of a listener, based on vocalization recorded by a microphone at each of a plurality of loudspeakers;
extract a set of DI features from the DI pattern data;
provide the set of DI features to a trained machine-learning model; and
determine, by the trained machine-learning model and based on the set of DI features, a placement of each of the plurality of loudspeakers relative to the listener.

13. A system comprising:
a plurality of loudspeakers;
a plurality of microphones, each microphone co-located with at least one of the plurality of loudspeakers such that each of the plurality of loudspeakers is co-located with at least one of the plurality of microphones; and
one or more non-transitory computer readable storage media storing instructions; and one or more processors coupled to the one or more non-transitory computer readable storage media and operable to execute the instructions to:
determine human directivity index (DI) pattern data corresponding to a location of the listener, based on the vocalization recorded by the plurality of microphones;
extract a set of DI features from the DI pattern data;
provide the set of DI features to a trained machine-learning model; and
determine, by the trained machine-learning model and based on the set of DI features, a placement of each of the plurality of loudspeakers relative to the listener.

14. The system of claim 13, further comprising one or more processors configured to execute the instructions to adjust, based on the determined placement of each of the plurality of loudspeakers relative to the listener, an audio playback setting of one or more of the plurality of loudspeakers.

15. The system of claim 14, wherein the audio playback setting comprises a spatial perception correction.

16. The system of claim 13, wherein the placement comprises a distance of each of the plurality of loudspeakers relative to the listener.

17. The system of claim 13, wherein the placement comprises an angle of each of the plurality of loudspeakers relative to the listener.

18. The system of claim 13, wherein the trained machine-learning model comprises a trained neural network.

19. The system of claim 18, wherein the trained neural network is specific to a number of loudspeakers of the plurality of loudspeakers.

20. The system of claim 13, wherein the DI pattern data comprises a DI value in each of a plurality of frequency bands for each of the plurality of loudspeakers.
